(19) United States
(12) Patent Application Publication
(10) Pub. No.: US 2025/0013929 A1
(43) Pub. Date: Jan. 9, 2025

(54) POLICY DRIVEN INTELLIGENT TELEMETRY CONTROLLER

(71) Applicant: Dell Products, L.P., Round Rock, TX (US)

(72) Inventors: Sisir Samanta, Round Rock, TX (US); Bridget Cate, Taylors, SC (US); Elie Antoun Jreij, Pflugerville, TX (US); Shibi Panikkar, Bangalore (IN)

(73) Assignee: Dell Products, L.P., Round Rock, TX (US)

(21) Appl. No.: 18/347,679

(22) Filed: Jul. 6, 2023

(51) Int. Cl. G06N 20/10

(52) U.S. Cl. CPC G06N 20/10

(57) ABSTRACT

A policy driven intelligent telemetry controller may collect network utilization for one or more applications, processes and/or subnetworks, at predetermined time intervals; may implement a policy configuration for telemetry transfer control, to define business critical, and/or time sensitive, application data and entity data; may use a support vector machine (SVM) classification model applied to historical network bandwidth utilization data for application data and entity data and a policy configuration of data criticality, to classify and create a cluster for each critical data set of the application data and entity data; may use linear regression to predict future network bandwidth demand variations for each cluster, across a plurality of time frames; and may use a resulting predicted network bandwidth to transfer critical data sets during a specific time window.

### FIELD

This disclosure relates generally to Information Handling Systems (IHSs), and, more specifically, to a policy driven intelligent telemetry controller.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Edge computing is a distributed computing model that brings computation and data storage closer to the sources of data. This improves response times and saves bandwidth. Edge computing is an architecture rather than a specific technology. In edge computing data is acted on near its creation point to generate immediate, essential value. Looking at the evolution of computing, it can be seen that cloud computing swung the pendulum from powerful devices to powerful networks. New types of workloads, distributed computing and the advent of the internet of things have shifted computing toward the network edge. Network bandwidth shifts as enterprises move compute and data to the edge. Traditionally, enterprises allocate higher bandwidth to data centers and lower bandwidth to endpoints.

The industry follows a standard process of predefined schedule mechanism for transfer of individual data types. For example, server health information is typically transferred once per minute, storage utilization is typically transferred once per hour, and security configuration is typically transferred once in a day.

### SUMMARY

Embodiments of policy driven intelligent telemetry controller are described. In an illustrative, non-limiting example a policy driven intelligent telemetry controller may collect network utilization for one or more applications, processes and/or subnetworks, at predetermined time intervals; may implement a policy configuration for telemetry transfer control, to define business critical, and/or time sensitive, application data and entity data; may use a support vector machine (SVM) classification model applied to historical network bandwidth utilization data for application data and entity data and a policy configuration of data criticality, to classify and create a cluster for each critical data set of the application data and entity data; may use linear regression to predict future network bandwidth demand variations for each cluster, across a plurality of time frames; and may use a resulting predicted network bandwidth to transfer critical data sets during a specific time window. The IHS is an edge gateway.

In an example, the IHS may dynamically schedule instructions for telemetry transfer of application data and entity data, based, at least in part, on the resulting predicted network bandwidth to use the result, such as, to queue the application data and entity data for transfer, according to the resulting schedule instructions.

The IHS may collect network utilization for one or more applications, processes and/or subnetworks, at predetermined time intervals, to provide the historical network bandwidth utilization data for application data and entity data, such as wherein the network utilization for each application data or entity data set comprises a historical transfer time and bandwidth allocation.

The IHS may implement a policy configuration for telemetry transfer control, to define business critical, and/or time sensitive, application data and entity data to define the policy configuration of data criticality.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram illustrating components of an example of an Information Handling System (IHS), according to some embodiments.

FIG. 2 is a diagrammatic illustration of an example implementation of an example of a policy driven intelligent telemetry controller, according to some embodiments.

FIG. 3 is a flowchart of an example of policy driven intelligent telemetry control, according to some embodiments.

FIG. 4 is a further detailed diagrammatic illustration of implementation of an example of a policy driven intelligent telemetry controller, according to some embodiments.

FIG. 5 is a diagrammatic illustration of an example of data clusters created and used by a policy driven intelligent telemetry controller for policy driven intelligent telemetry control, according to some embodiments.

### DETAILED DESCRIPTION

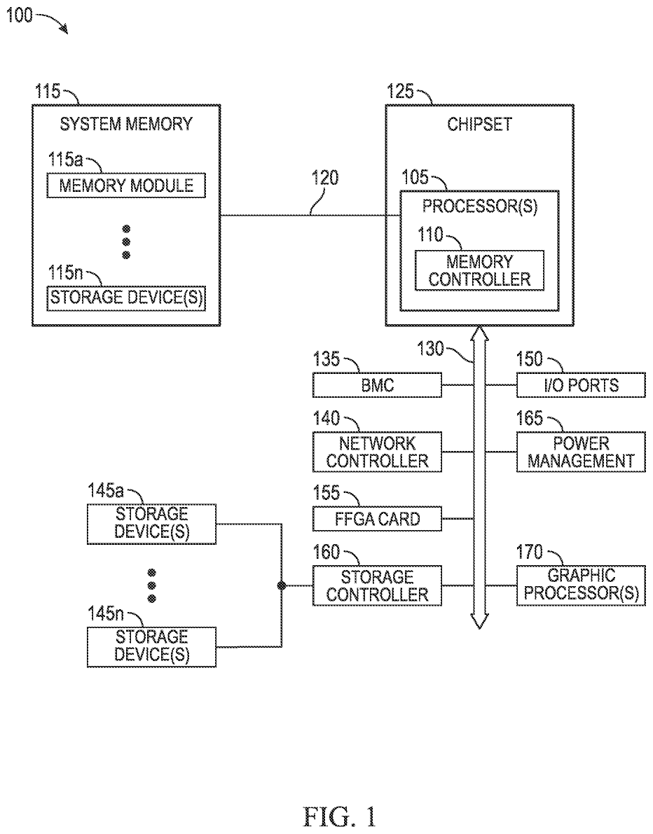

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., personal digital assistant (PDA) or smart phone), a network storage device, server (e.g., blade server or rack server), which, in accordance with embodiments of the present policy driven intelligent telemetry control may be an edge gateway, or any other suitable device and may vary in size, shape, performance, functionality, and price. Herein, embodiments of the present policy driven intelligent telemetry controller are described below with respect to a server, or the like. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components. A more detailed example of an IHS (100) is described with respect to FIG. 1.

IHS 100 may utilize one or more processors 105. In some embodiments, processors 105 may include a main processor and a co-processor, each of which may include a plurality of processing cores that, in certain scenarios, may each be used to run an instance of a server process. In certain embodiments, one or all of processor(s) 105 may be graphics processing units (GPUs) in scenarios where IHS 100 has been configured to support functions such as multimedia services and graphics applications.

As illustrated, processor(s) 105 includes an integrated memory controller 110 that may be implemented directly within the circuitry of the processor 105, or the memory controller 110 may be a separate integrated circuit that is located on the same die as the processor 105. The memory controller 110 may be configured to manage the transfer of data to and from the system memory 115 of the IHS 105 via a high-speed memory interface 120. The system memory 115 is coupled to processor(s) 105 via a memory bus 120 that provides the processor(s) 105 with high-speed memory used in the execution of computer program instructions by the processor(s) 105. Accordingly, system memory 115 may include memory components, such as static RAM (SRAM), dynamic RAM (DRAM), NAND Flash memory, suitable for supporting high-speed memory operations by the processor(s) 105. In certain embodiments, system memory 115 may combine both persistent, non-volatile memory and volatile memory.

In certain embodiments, the system memory 115 may be comprised of multiple removable memory modules. The system memory 115 of the illustrated embodiment includes removable memory modules 115a-n. Each of the removable memory modules 115a-n may correspond to a printed circuit board memory socket that receives a removable memory module 115a-n, such as a DIMM (Dual In-line Memory Module), that can be coupled to the socket and then decoupled from the socket as needed, such as to upgrade memory capabilities or to replace faulty memory modules. Other embodiments of IHS memory 115 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 100 may utilize chipset 125 that may be implemented by integrated circuits that are coupled to processor(s) 105. In this embodiment, processor(s) 105 is depicted as a component of chipset 125. In other embodiments, all of chipset 125, or portions of chipset 125 may be implemented directly within the integrated circuitry of processor(s) 105. The chipset may provide the processor(s) 105 with access to a variety of resources accessible via one or more buses 130. Various embodiments may utilize any number of buses to provide the illustrated pathways served by bus 130. In certain embodiments, bus 130 may include a PCIe switch fabric that is accessed via a PCIe root complex.

As illustrated, IHS 100 includes BMC 135 to provide capabilities for remote monitoring and management of various aspects of IHS 100. In support of these operations, BMC 135 may utilize both in-band, sideband and/or out of band communications with certain managed components of IHS 100, such as, for example, processor(s) 105, system memory 115, chipset 125, network controller 140, storage device(s) 145, etc. BMC 135 may be installed on the motherboard of IHS 100 or may be coupled to IHS 100 via an expansion slot provided by the motherboard. As a non-limiting example of a BMC, the integrated Dell Remote Access Controller (iDRAC) from Dell® is embedded within Dell PowerEdge™ servers and provides functionality that helps information technology (IT) administrators deploy, update, monitor, and maintain servers remotely. BMC 135 may include non-volatile memory having program instructions stored thereon that are usable by CPU(s) 105 to enable remote management of IHS 100. For example, BMC 135 may enable a user to discover, configure, and manage BMC 135, setup configuration options, resolve and administer hardware or software problems, etc. Additionally, or alternatively, BMC 135 may include one or more firmware volumes, each volume having one or more firmware files used by the BIOS' firmware interface to initialize and test components of IHS 100.

IHS 100 may also include the one or more I/O ports 150, such as USB ports, PCIe ports, TPM (Trusted Platform Module) connection ports, HDMI ports, audio ports, docking ports, network ports, Fibre Channel ports and other storage device ports. Such I/O ports 150 may be externally accessible or may be internal ports that are accessed by opening the enclosure of the IHS 100. Through couplings made to these I/O ports 150, users may couple the IHS 100 directly to other IHSs, storage resources, external networks and a vast variety of peripheral components.

As illustrated, IHS 100 may include one or more FPGA (Field-Programmable Gate Array) cards 155. Each of the FPGA card 155 supported by IHS 100 may include various processing and memory resources, in addition to an FPGA logic unit that may include circuits that can be reconfigured after deployment of IHS 100 through programming functions supported by the FPGA card 155. Through such reprogramming of such logic units, each individual FGPA card 155 may be optimized to perform specific processing tasks, such as specific signal processing, security, data mining, and artificial intelligence functions, and/or to support specific hardware coupled to IHS 100. In some embodiments, a single FPGA card 155 may include multiple FPGA logic units, each of which may be separately programmed to implement different computing operations, such as in computing different operations that are being offloaded from processor 105.

IHS 100 may include one or more storage controllers 160 that may be utilized to access storage devices 145a-n that are accessible via the chassis in which IHS 100 is installed. Storage controller 160 may provide support for RAID (Redundant Array of Independent Disks) configurations of logical and physical storage devices 145a-n. In some embodiments, storage controller 160 may be an HBA (Host Bus Adapter) that provides more limited capabilities in accessing physical storage devices 145a-n. In some embodiments, storage devices 145a-n may be replaceable, hot-swappable storage devices that are installed within bays provided by the chassis in which IHS 100 is installed. In embodiments where storage devices 145a-n are hot-swappable devices that are received by bays of chassis, the storage devices 145a-n may be coupled to IHS 100 via couplings between the bays of the chassis and a midplane of IHS 100. In some embodiments, storage devices 145a-n may also be accessed by other IHSs that are also installed within the same chassis as IHS 100. Storage devices 145a-n may include SAS (Serial Attached SCSI) magnetic disk drives, SATA (Serial Advanced Technology Attachment) magnetic disk drives, solid-state drives (SSDs) and other types of storage devices in various combinations.

Processor(s) 105 may also be coupled to a network controller 140 via bus 130, such as provided by a Network Interface Controller (NIC) that allows the IHS 100 to communicate via an external network, such as the Internet or a LAN. In some embodiments, network controller 140 may be a replaceable expansion card or adapter that is coupled to a motherboard connector of IHS 100. In some embodiments, network controller 140 may be an integrated component of IHS 100.

A variety of additional components may be coupled to processor(s) 105 via bus 130. For instance, processor(s) 105 may also be coupled to a power management unit 165 that may interface with a power supply of IHS 100. In certain embodiments, a graphics processor 170 may be comprised within one or more video or graphics cards, or an embedded controller, installed as components of the IHS 100.

In certain embodiments, IHS 100 may operate using a BIOS (Basic Input/Output System) that may be stored in a non-volatile memory accessible by the processor(s) 105. The BIOS may provide an abstraction layer by which the operating system of the IHS 100 interfaces with the hardware components of the IHS. Upon powering or restarting IHS 100, processor(s) 105 may utilize BIOS instructions to initialize and test hardware components coupled to the IHS, including both components permanently installed as components of the motherboard of IHS 100 and removable components installed within various expansion slots supported by the IHS 100. The BIOS instructions may also load an operating system for use by the IHS 100. In certain embodiments, IHS 100 may utilize Unified Extensible Firmware Interface (UEFI) in addition to or instead of a BIOS. In certain embodiments, the functions provided by a BIOS may be implemented, in full or in part, by the remote access controller 135. In some embodiments, BIOS may be configured to identify hardware components that are detected as being currently installed in IHS 100. In such instances, the BIOS may support queries that provide the described unique identifiers that have been associated with each of these detected hardware components by their respective manufacturers. In providing an abstraction layer by which hardware of IHS 100 is accessed by an operating system, BIOS may identify the I/O ports 150 that are recognized and available for use.

In some embodiments, IHS 100 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 100. These calculated hash values may then be compared against reference hash values that were previously stored in a secure non-volatile memory of the IHS, such as during factory provisioning of IHS 100. In this manner, a TPM may establish a root of trust that includes core components of IHS 100 that are validated as operating using instructions that originate from a trusted source.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 105 as a systems-on-a-chip.

A person of ordinary skill in the art will appreciate that IHS 100 is merely illustrative and is not intended to limit the scope of the disclosure described herein. In particular, any computer system and/or device may include any combination of hardware or software capable of performing certain operations described herein. In addition, the operations performed by the illustrated components may, in some embodiments, be performed by fewer components or distributed across additional components. Similarly, in other embodiments, the operations of some of the illustrated components may not be performed and/or other additional operations may be available.

A person of ordinary skill will recognize that IHS 100 of FIG. 1 is only one example of a system in which the certain embodiments may be utilized. Indeed, the embodiments described herein may be used in, or in conjunction with various electronic devices, such as network router devices, Internet of Things (IoT) devices, custom telecommunications equipment for special purpose use, etc., particularly edge (computing) devices, as well as edge gateways, and the like. That is, certain techniques described herein are in no way limited to use with the IHS of FIG. 1.

Edge computing is driving a need for more bandwidth across networks. Even with the advent of 5G, bandwidth is limited. Utilization of network bandwidth is important to run seamless business functions at the edge. Transfer of telemetry data (e.g., usage utilization, performance metrics, security configuration, business data, etc.) to cloud (a) server(s) is one of the key functions that consumes significant amount of network bandwidth, and on many occasions, utilization of network bandwidth causes significant performance impact in business function. One significant problem is, how much bandwidth is expected to be reserved for a data set for specific hours or days, of time.

As noted, industry follow a standard process of a predefined transfer schedule mechanism based on individual data type. For example, server health information is typically transferred once per minute, storage utilization is typically transferred once per hour, and security configuration is typically transferred once in a day. With this mechanism, telemetry process transfers the data in a fixed schedule time without understanding the current network utilization and hence it cause significant impact in critical business process.

Recently, intelligent network bandwidth optimization is on a by process, by application, by server, or by sub-net basis. However, this does not give control to decide if part of the data produced by a process, or by an application, needs to be transferred, or not transferred, over the network. Such bandwidth optimization gives either all, or nothing, control to one server, via one application. This throttles the bandwidth for all transferring process instead of allocating the available bandwidth to a specific data transfer. One way to address this may be with an application feed demand request for a specific data set. However, this does not solve demand prediction for a specific type of data set during a specific hour and/or day, or the like.

As noted, the present disclosure is directed to embodiments of a policy driven intelligent telemetry controller. Embodiments of the present policy driven intelligent telemetry controller intelligently understand the historical network utilization behavior and data criticality using Artificial Intelligence (AI) methodologies and policy configuration. Embodiments of the present policy driven intelligent telemetry controller are implemented as a software component to predict network bandwidth demand for a business data set and telemetry data transfer, based on set business policy and past network bandwidth utilization by the data set, over a different timeframe, for example time of a day and/or month. Embodiments of the present policy driven intelligent telemetry controller intelligently create telemetry transfer schedule instructions based on allowing no impact of bandwidth in critical business functions.

In accordance with some embodiments, as further detailed below, a policy driven intelligent telemetry controller may collect network utilization for one or more applications, processes and/or subnetworks, at predetermined time intervals; may implement a policy configuration for telemetry transfer control, to define business critical, and/or time sensitive, application data and entity data; may use a support vector machine (SVM) classification model applied to historical network bandwidth utilization data for application data and entity data and a policy configuration of data criticality, to classify and create a cluster for each critical data set of the application data and entity data; may use linear regression to predict future network bandwidth demand variations for each cluster, across a plurality of time frames; and may use a resulting predicted network bandwidth to transfer critical data sets during a specific time window.

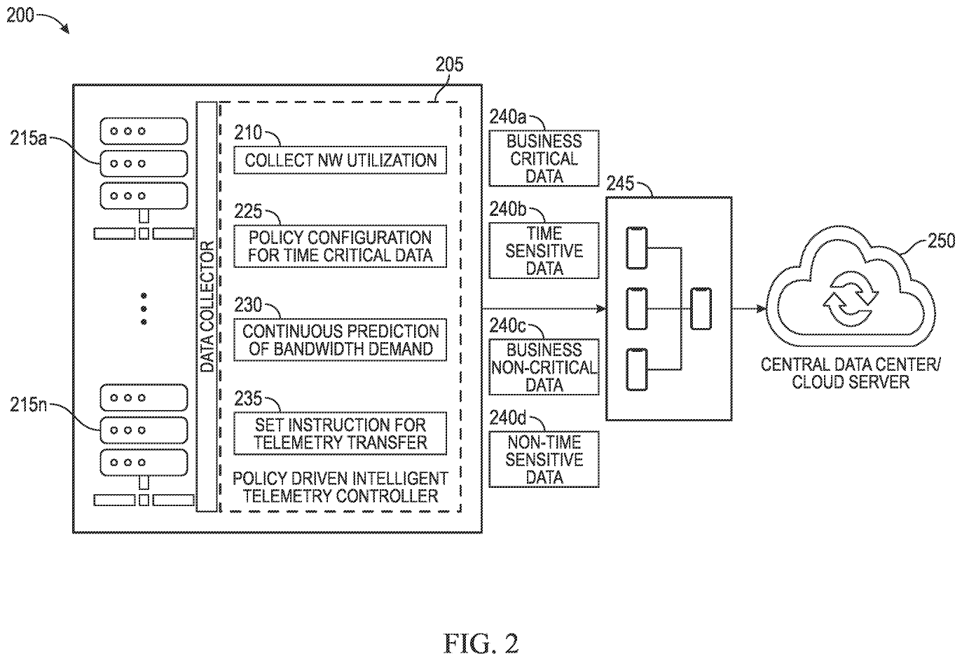

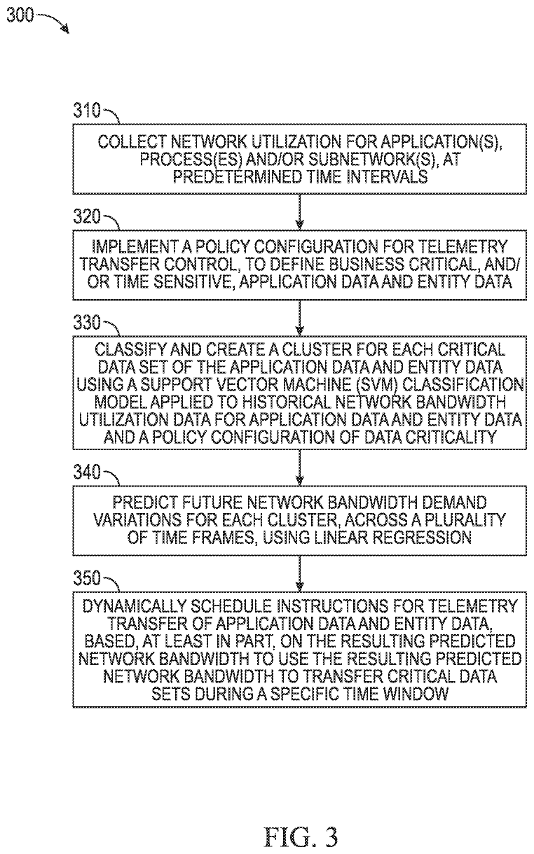

FIG. 2 is a diagrammatic illustration of example implementation 200 of an example of a policy driven intelligent telemetry controller 205, according to some embodiments and FIG. 3 is a flowchart of example of policy driven intelligent telemetry control 300, according to some embodiments. Policy driven intelligent telemetry controller 205 may implement policy driven intelligent telemetry control 300 in an IHS such as an edge gateway, or the like.

With respect to FIGS. 2 and 3, service 210 may be employed by policy driven intelligent telemetry controller 205 to collect network utilization every few minute for each application, process and sub-net. In accordance therewith, network utilization for one or more applications, processes and/or subnetworks, is collected at predetermined time intervals, to provide historical network bandwidth utilization data for application data and entity data at 310. This network utilization may be collected for one or more server 215a through n, via data collector 220, or the like, and may include, for each application data or entity data set, a historical transfer time and bandwidth allocation.

Policy configuration for intelligent telemetry transfer control is employed to define policy driven intelligent telemetry control for business critical, time sensitive application and entity data, by policy driven intelligent telemetry controller 205, such as policy configuration for time critical data 225. In accordance therewith, such a policy configuration for telemetry transfer control may be used at 320 to define business critical, and/or time sensitive, application data and entity data to define a policy configuration of data criticality.

The historical data for network bandwidth utilization behavior from 310 and the policy configuration for data criticality from 320 is used in accordance with embodiments of present policy driven intelligent telemetry control 300 to classify and create a cluster for each critical data sets using a Machine Learning (ML) Support Vector Machine (SVM) classification model, at 330. For example, the SVM classification model may be a linear classification model, non-linear classification mapping the data sets into high-dimensional clusters using the set policy, or the like).

For each cluster, future network (bandwidth) demand variations, spread across hours and/or days, may be predicted, using an AI ML linear regression, or the like, such as through policy driven intelligent telemetry controller continuous prediction of bandwidth demand 230, at 340. A resulting predicted network bandwidth to transfer critical data sets during a specific time window may, for each data set, include time of day to make the transfer and a network bandwidth to use to transfer the data set.

Policy driven intelligent telemetry controller 205 uses the predicted bandwidth for critical data sets for a specific time window to, by way of example, to dynamically schedule instructions for telemetry transfer of application data and entity data, based, at least in part, on the predicted network bandwidth resulting at 340, such as by policy driven intelligent telemetry controller to set instructions for telemetry transfer 235, to transfer critical data sets during a specific time window, at 350.

As a result, data set clusters, such as comprising business critical data 240a, time sensitive data 240b, business non-critical data 240c, non-time sensitive data 240d may be scheduled for transfer and buffered at 245, for telemetry transfer to central data center/cloud server 250, or the like. As a result, the application data and entity data may be queued for transfer, according to the schedule instructions resulting at 350.

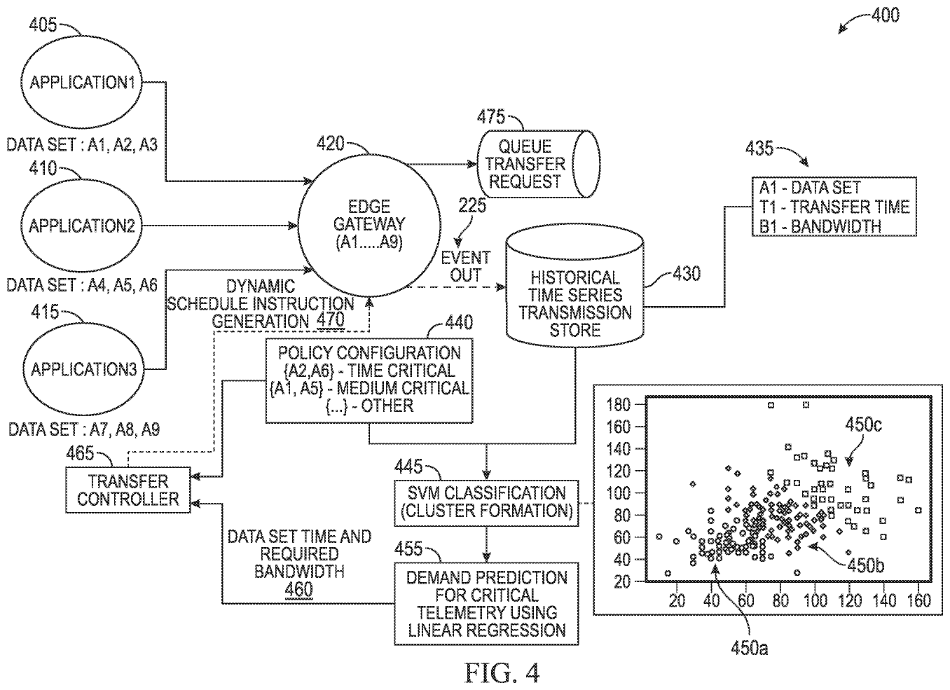

FIG. 4 is a further detailed diagrammatic illustration of implementation 400 of an example of policy driven intelligent telemetry control, such as by a policy driven intelligent telemetry controller, according to some embodiments. Therein, data sets A1, A2 and A3 of or from Application1 (405), data sets A4, A5 and A6 of or from Application2 (410), and data sets A7, A8 and A9 of or from Application3 (415), are shown a being provided to edge gateway (IHS) 420.

In response to an event (425), or the like, historical time series transmission data is collected (310) in database 430. This historical time series transmission data may include a historical transfer time and bandwidth allocation for application data set (A1 through A9, in the illustrated example). Example application data set A1 historical transfer time and bandwidth allocation record 435 is shown in FIG. 4.

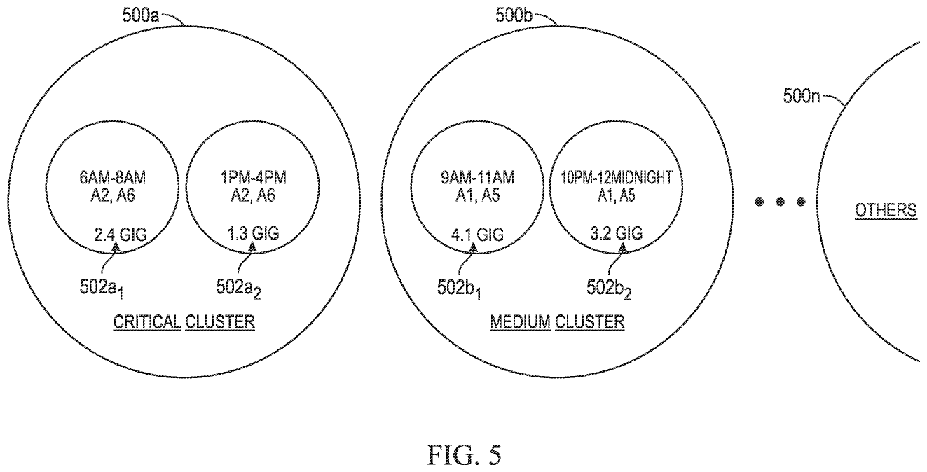

This collected historical network bandwidth utilization data for the application data (A1 through A9, in the illustrated example) is used with policy configuration of data criticality 440, by a SVM classification model 445 to form (classify and create) a cluster 450a through n for each (critical) data set of the application data. In the example of FIG. 4, in set policy configuration 440, Application1 (405) dataset A2 and Application2 (410) dataset A6 are set as time critical, Application1 (405) dataset A1 and Application2 (410) dataset A5 are set as “medium” critical, etc. FIG. 5 is a diagrammatic illustration of example data clusters 500a through 500n, such as may be used by a policy driven intelligent telemetry controller for policy driven intelligent telemetry control (400), according to various embodiments described herein.

At 455, a demand prediction for critical telemetry is made, using AI ML linear regression, or the like. For example, linear regression may be used to predict future network bandwidth demand variations for each cluster, across a plurality of time frames (hours and days). This resulting predicted network bandwidth to transfer critical data sets during a specific time window may include, for each data set, a time to make the transfer and a network bandwidth to use to transfer the data set (460).

Returning to FIG. 5, in accordance with FIG. 4 (430 through 455), resulting data set time and required bandwidth 460 results in clusters 500a through n. Critical cluster 500a is comprised of Application1 (405) dataset A2 and Application2 (410) dataset A6 with a transfer time of 6:00 am to 8:00 am, with an allocated network bandwidth of 2.4 Gigahertz (502a₁), and with a transfer time of 1:00 pm to 4:00 pm, with an allocated network bandwidth of 1.3 Gigahertz (502a₂), respectively. Whereas, medium (cricality) cluster 500b is comprised of Application1 (405) dataset A1 and Application2 (410) dataset A5 with a transfer time of 9:00 am to 11:00 am, with an allocated network bandwidth of 4.1 Gigahertz (502b₁), and with a transfer time of 10:00 pm to 12:00 midnight, with an allocated network bandwidth of 3.2 Gigahertz (502a₂), respectively.

Returning to FIG. 4, data set time and required bandwidth 460 is used (with policy configuration 440) by transfer controller 465 to dynamically schedule instructions (470) to edge gateway 420, for telemetry transfer of application data A1 through 9 to use the predicted network bandwidth to transfer the data sets during the specific time windows. Edge gateway 420 may then queue the transfer(s) as requests, at 475.

In accordance with the foregoing, embodiments of the present policy driven intelligent telemetry controller may be a software component to predict network bandwidth demand for business data set and telemetry data transfer, based on a business policy set and past utilization over different time of a day, month, etc. As described, embodiments of the present policy driven intelligent telemetry controller may intelligently create telemetry transfer schedule instructions based on allowing no impact of bandwidth in critical business functions.

Thus, it should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As noted, in various embodiments, aspects of systems and methods described herein may be implemented, at least in part, using A1 and ML. As used herein, the terms “artificial intelligence,” “A1,” “machine learning,” or “ML” may refer to one or more algorithms that implement: linear regression, SVM (e.g., linear SVM, nonlinear SVM, SVM regression, etc.), a neural network (e.g., artificial neural network, deep neural network, convolutional neural network, recurrent neural network, autoencoders, reinforcement learning, etc.), fuzzy logic, deep learning, deep structured learning hierarchical learning, decision tree learning (e.g., classification and regression tree or “CART”), Very Fast Decision Tree (VFDT), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), or the like.

Non-limiting examples of publicly available A1 and/or ML algorithms, software, and libraries that may be utilized within embodiments of systems and methods described herein include, but are not limited to: PYTHON, OPENCV, INCEPTION, THEANO, TORCH, PYTORCH, PYLEARN2, NUMPY, BLOCKS, TENSORFLOW, MXNET, CAFFE, LASAGNE, KERAS, CHAINER, MATLAB Deep Learning, CNTK, MatConvNet (a MATLAB toolbox implementing convolutional neural networks for computer vision applications), DeepLearnToolbox (a Matlab toolbox for Deep Learning from Rasmus Berg Palm), BigDL, Cuda-Convnet (a fast C++/CUDA implementation of convolutional or feed-forward neural networks), Deep Belief Networks, RNNLM, RNNLIB-RNNLIB, matrbm, deeplearning4j, Eblearn.Ish, deepmat, MShadow, Matplotlib, SciPy, CXXNET, Nengo-Nengo, Eblearn, cudamat, Gnumpy, 3-way factored RBM and mcRBM, mPOT, ConvNet, ELEKTRONN, OpenNN, NEURALDESIGNER, Theano Generalized Hebbian Learning, Apache SINGA, Lightnet, and SimpleDNN.”

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, wherein the memory comprises program instructions stored thereon that, upon execution by the processor, cause the IHS to:
use a support vector machine (SVM) classification model applied to historical network bandwidth utilization data for application data and entity data and a policy configuration of data criticality, to classify and create a cluster for each critical data set of the application data and entity data;
use linear regression to predict future network bandwidth demand variations for each cluster, across a plurality of time frames; and
use a resulting predicted network bandwidth to transfer critical data sets during a specific time window.

2. The IHS of claim 1, wherein, upon execution, by the processor, the program instructions further cause the IHS to dynamically schedule instructions for telemetry transfer of application data and entity data, based, at least in part, on the resulting predicted network bandwidth to use the resulting predicted network bandwidth to transfer critical data sets during the specific time window.

3. The IHS of claim 2, wherein, upon execution, by the processor, the program instructions further cause the IHS to queue the application data and entity data for transfer, according to the resulting schedule instructions.

4. The IHS of claim 1, wherein, upon execution, by the processor, the program instructions further cause the IHS to collect network utilization for one or more applications, processes and/or subnetworks, at predetermined time intervals, to provide the historical network bandwidth utilization data for application data and entity data.

5. The IHS of claim 4, wherein the network utilization for each application data or entity data set comprises a historical transfer time and bandwidth allocation.

6. The IHS of claim 1, wherein, upon execution, by the processor, the program instructions further cause the IHS to implement a policy configuration for telemetry transfer control, to define business critical, and/or time sensitive, application data and entity data to define the policy configuration of data criticality.

7. The IHS of claim 1, wherein the IHS is an edge gateway.

8. A non-transitory computer-readable storage media storing program instructions, that when executed on or across one or more processors of an Information Handling System (IHS), cause the IHS to:
use a support vector machine (SVM) classification model applied to historical network bandwidth utilization data for application data and entity data and a policy configuration of data criticality, to classify and create a cluster for each critical data set of the application data and entity data, using;
use linear regression to predict future network bandwidth demand variations for each cluster, across a plurality of time frames; and
use a resulting predicted network bandwidth to transfer critical data sets during a specific time window.

9. The non-transitory computer-readable storage media of claim 8, wherein, when executed on or across the one or more processors, the program instructions further cause the IHS to dynamically schedule instructions for telemetry transfer of application data and entity data, based, at least in part, on the resulting predicted network bandwidth to use the resulting predicted network bandwidth to transfer critical data sets during the specific time window.

10. The non-transitory computer-readable storage media of claim 9, wherein, when executed on or across the one or more processors, the program instructions further cause the IHS to queue the application data and entity data for transfer, according to the resulting schedule instructions.

11. The non-transitory computer-readable storage media of claim 8, wherein, when executed on or across the one or more processors, the program instructions further cause the IHS to collect network utilization for one or more applications, processes and/or subnetworks, at predetermined time intervals, to provide the historical network bandwidth utilization data for application data and entity data.

12. The non-transitory computer-readable storage media of claim 11, wherein the network utilization for each application data or entity data set comprises a historical transfer time and bandwidth allocation.

13. The non-transitory computer-readable storage media of claim 8, wherein, when executed on or across the one or more processors, the program instructions further cause the IHS to implement a policy configuration for telemetry transfer control, to define business critical, and/or time sensitive, application data and entity data to define the policy configuration of data criticality.

14. The non-transitory computer-readable storage media of claim 8, wherein the IHS is an edge gateway.

15. A method comprising:
using a support vector machine (SVM) classification model, by an Information handling System (IHS), to classify and create a cluster for each critical data set of application data and entity data using historical network bandwidth utilization data for the application data and entity data, and a policy configuration of data criticality;
using linear regression, by the IHS, to predict future network bandwidth demand variations for each cluster, across a plurality of time frames; and
using a resulting predicted network bandwidth to transfer critical data sets during a specific time window.

16. The method of claim 15, further comprising using the resulting predicted network bandwidth to transfer critical data sets during the specific time window by dynamically scheduling instructions for telemetry transfer of application data and entity data, based, at least in part, on the resulting predicted network bandwidth.

17. The method of claim 16, further comprising queueing the application data and entity data for transfer, according to the resulting schedule instructions.

18. The method of claim 15, further comprising collecting network utilization for one or more applications, processes and/or subnetworks, at predetermined time intervals, to provide the historical network bandwidth utilization data for application data and entity data.

19. The method of claim 18, wherein the network utilization for each application data or entity data set comprises a historical transfer time and bandwidth allocation.

20. The method of claim 15, further comprises implementing a policy configuration for telemetry transfer control, to define business critical, and/or time sensitive, application data and entity data to define the policy configuration of data criticality.
